(19) United States
(12) Patent Application Publication
(10) Pub. No.: US 2006/0175840 A1
(43) Pub. Date: Aug. 10, 2006

(54) Battery cover latching assembly for portable electronic device

(75) Inventors: Guang-Jin Wang, Shenzhen (CN); Shui-Yuan Qin, Shenzhen (CN); Chia-Hua Chen, Tu-Cheng (TW); Hsiao-Hua Tu, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: FIH CO., LTD, Shindian City (TW)

(21) Appl. No.: 11/347,497

(22) Filed: Feb. 3, 2006

(30) Foreign Application Priority Data
Feb. 4, 2005 (CN) 200520054790.8

(51) Int. Cl. E05C 3/14

(52) U.S. Cl. 292/228

(57) ABSTRACT

A battery cover latching assembly (30) is used in a portable electronic device (9). The portable electronic device has a housing (10) and a battery cover (20) releasably connected via the battery cover latching assembly. The housing has a button hole (171) defined in one end portion thereof. The battery cover latching assembly has a button (40) and a spring (50). The button and the spring are installed in the button hole of the housing. The button is movable relative to the housing for assembling or disassembling the battery cover to or from the housing.

### BACKGROUND OF THE INVENTION

1. Field of the Invention

The present invention generally relates to battery cover latching assemblies and, more particularly, to a battery cover latching assembly for use in a portable electronic device.

2. Discussion of the Related Art

Batteries are widely used in portable electronic devices, such as personal digital assistants (PDAs), mobile phones and so on. Some batteries are attachably received in housings of the electronic devices, and battery covers are designed to connect with the housings to package the batteries. The battery has to be replaced by opening the battery cover when the battery is, e.g., damaged, dead, and/or in need of recharging or replacement.

A clasping structure or latching structure is generally used to engage a battery cover with a housing of a portable electronic device. For example, a mobile phone marked Alcatel OT310 has a latching assembly for a battery cover thereof. The latching assembly includes a pair of hooks formed at one end of the battery cover and a locking pin protruding from the other opposite end of the battery cover. Accordingly, a pair of grooves is defined in one end portion of a backside of a housing of the mobile phone, and a locking hole is defined in the other opposite end portion of the backside of the housing. In assembly, the hooks of the battery cover are firstly inserted into the grooves of the housing, respectively. Then, the battery cover is pressed downwardly to the housing until the locking pin of the battery cover is inserted into the locking hole of the housing. The battery cover is thus assembled to the housing of the mobile phone. The latching assembly is simple in structure, and the engagement between the battery cover and the housing of the mobile phone is firm, too. However, during disassembly, great effort is needed to disassemble the battery cover from the housing, thereby requiring a substantial force to be exerted thereon. Therefore, the battery cover is susceptible to damage. As a result, it is inconvenient for a user to replace a battery in the housing of the mobile phone.

Therefore, a new battery cover latching assembly is desired in order to overcome the above-described shortcomings.

### SUMMARY OF THE INVENTION

In one embodiment thereof, a battery cover latching assembly is adapted for use in a portable electronic device. The portable electronic device has a battery cover and a housing releasably connected via the battery cover latching assembly. The housing has a button hole defined in one end portion thereof. The battery cover latching assembly has a button and a spring. The button and the spring are installed in the button hole of the housing. The button is movable relative to the housing for assembling or disassembling the battery cover to or from the housing.

Other advantages and novel features of the embodiments will become more apparent from the following detailed description thereof when taken in conjunction with the accompanying drawings.

### BRIEF DESCRIPTION OF THE DRAWINGS

Many aspects of the present battery cover latching assembly can be better understood with reference to the following drawings. The components in the drawings are not necessarily to scale, the emphasis instead being placed upon clearly illustrating the principles of the battery cover latching assembly and its potential applications. Moreover, in the drawings, like reference numerals designate corresponding parts throughout the several views.

FIG. 1 is an exploded, isometric view of a battery cover latching assembly in accordance with a preferred embodiment of the present invention, together with a battery cover and a housing of a portable electronic device;

FIG. 2 is similar to FIG. 1, but viewed from another aspect;

FIG. 3 is a cut-away view of the housing shown in FIG. 1;

FIG. 4 is an enlarged, isometric view of a button of the battery cover latching assembly shown in FIG. 2;

FIG. 5 is an assembled, isometric view of the portable electronic device shown in FIG. 1;

FIG. 6 is a partly across-sectional view of the portable electronic device of FIG. 5 along line VI-VI thereof, showing the button in a first position; and

FIG. 7 is similar to FIG. 6, but showing the button in a second position.

### DETAILED DESCRIPTION OF THE EMBODIMENTS

The present battery cover latching assembly is suitable for portable electronic devices such as mobile phones, PDAs, and so on.

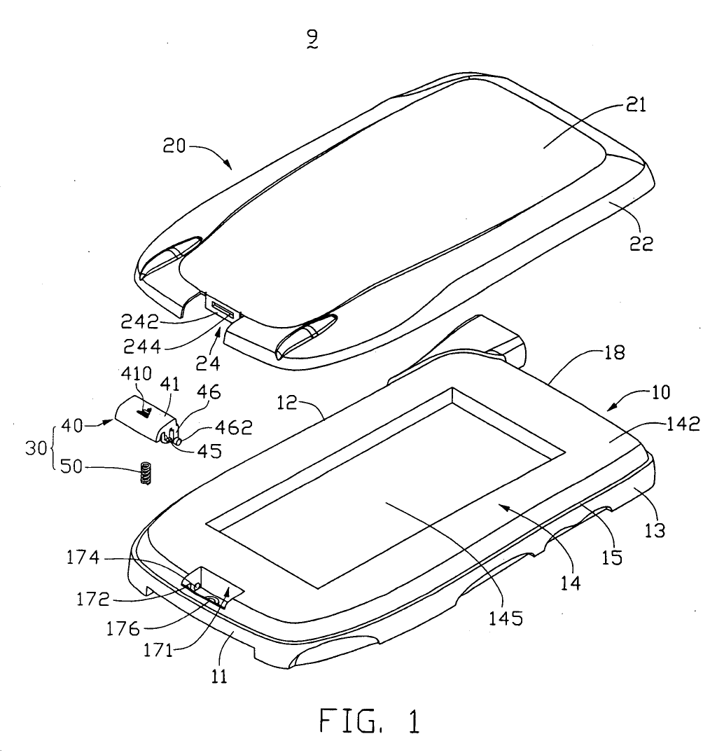

Referring now to the drawings in detail, FIG. 1 shows a battery cover latching assembly 30 for use in a mobile phone 9. The mobile phone 9 is taken here as an exemplary application, for the purposes of describing details of the battery cover latching assembly 30 of a preferred embodiment of the present assembly. The mobile phone 9 includes a housing 10 and a battery cover 20 connected via the battery cover latching assembly 30.

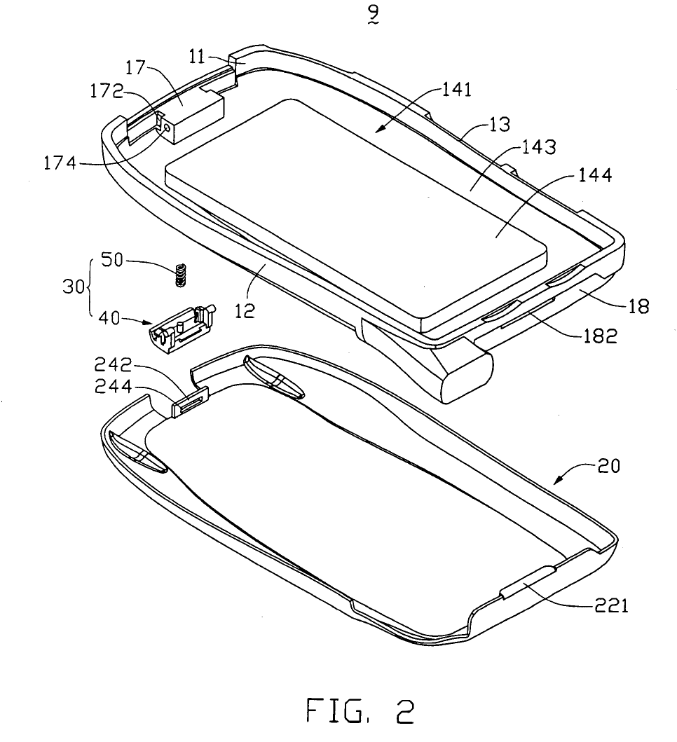

Also referring to FIG. 2, the housing 10 includes a housing body 14. The housing body 14 is substantially rectangular and has an outer side 142 and an inner side 143. A top wall 18, a bottom wall 11, a left flange 12, and a right flange 13 all extend from an edge of the housing body 14 toward a same direction thereby defining an inner cavity 141 therebetween. The inner cavity 141 is configured for accommodating electronic elements (not shown) of the mobile phone 9, such as a printed circuit board, therein, when the housing 10 is assembled with other housings of the mobile phone 9. A center portion of the housing body 14 is recessed inwardly to form a cavity 145 in the outer side 142, and therefore form a corresponding cuboidal block 144 on the inner side 143. The cavity 145 is used for accommodating a battery (not shown) therein. A peripheral groove 15 is defined along a circumference of the housing body 14. A positioning slot 182 is defined in the top wall 18.

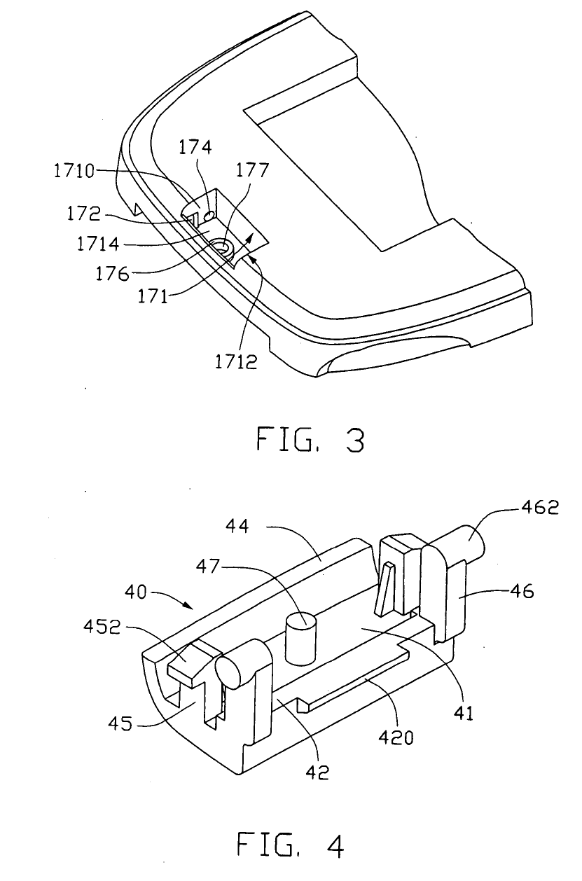

Referring also to FIG. 3, a bottom edge portion of the housing body 14 is recessed inwardly to form a protrusion 17 on the inner side 143 of the housing body 14, and therefore form a corresponding button hole 171 in the outer side 142 of the housing body 14. The protrusion 17 is substantially rectangular and includes opposite left and right sidewalls 1710,1712, and a bottom board 1714 connecting the left and right sidewalls 1710,1712. A pair of aligned rectangular holes 172 is respectively defined in the left and right sidewalls 1710,1712 of the protrusion 17, adjacent the bottom wall 11. A pair of aligned round holes 174 is respectively defined in the left and right sidewalls 1710,1712 of the protrusion 17, adjacent the rectangular holes 174. An annular protrusion 176 is formed on the bottom board 1714 of the protrusion 17, extending into the button hole 171. The annular protrusion 176 defines a mounting hole 177 therein.

The battery cover 20 has a cover body 21 and a cover sidewall 22. The cover body 21 is substantially a rectangular board. The cover sidewall 22 extends from a circumference of the cover body 21, corresponding to the groove 15. A positioning piece 221 is formed on the cover sidewall 22 at a top end of the cover 20, for engaging in the positioning slot 182 of the housing 10. A cutout 24 is defined in the cover 20 at an opposite bottom end thereof, aligning with the button hole 171 of the housing 10. A locking flake 242 extends toward the housing 10 from the cover body 21 at a top extremity of the cutout 24. A locking slot 244 is defined in a center portion of the locking flake 242.

Also referring to FIG. 4, the battery cover latching assembly 30 includes a button 40 and a spring 50. The battery cover latching assembly 30 is to be engaged in the button hole 171 of the housing 10 and is movable relative to the housing 10.

The button 40 includes a button body 41, a first sidewall 42, and a second sidewall 44. The two sidewalls 42,44 extend from two opposite first sides of the button body 41. A locking projection 420 extends perpendicularly from a distal end of the first sidewall 42, and away from the button body 41. The locking projection 420 is for engaging into the locking slot 244 of the locking flake 242. A pair of first legs 45 respectively extends from the other two opposite second sides of the button body 41 in a same direction as the extending direction of the first sidewall 42 and the second sidewall 44, and adjacent the second sidewall 44. A barb 452 extends perpendicularly outward from a distal end of each first leg 45. The barb 452 is substantially in the form of a wedge and is used to engage in the rectangular hole 172 of the housing 10 to connect the button 40 with the housing 10. A pair of second legs 46 respectively extends from the second sides of the button body 41 in a same direction as the extending direction of the first legs 45. A pivot pin 462 extends perpendicularly outward from a distal end of each second leg 46. The pivot pin 462 is substantially in the form of a cylinder. The pivot pin 462 is used to rotatably engage in the round hole 174 of the housing 10. A positioning pole 47 extends from a center portion of the button body 41 in the same direction as the extending direction of the first sidewall 42 and the second sidewall 44. The positioning pole 47 may be made of elastic material. A pusher 410 is formed on an outer surface of the button body 41, for pushing operation of the button 40.

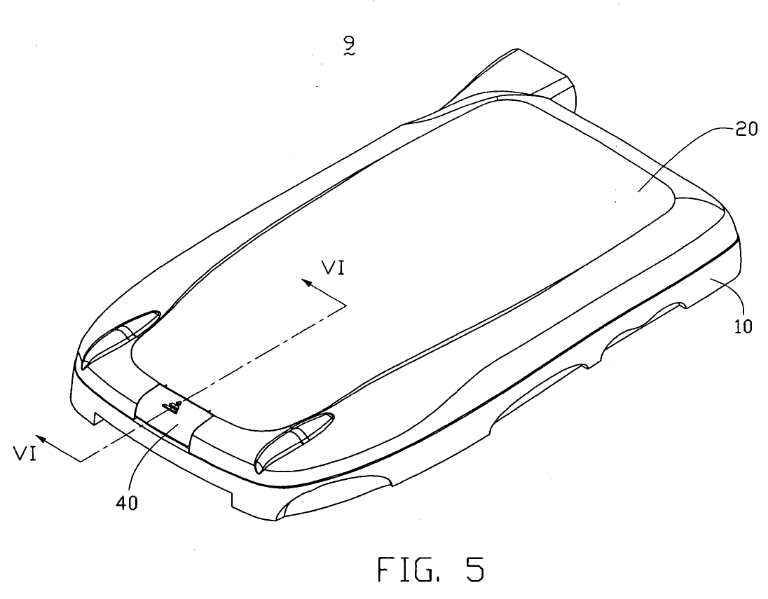

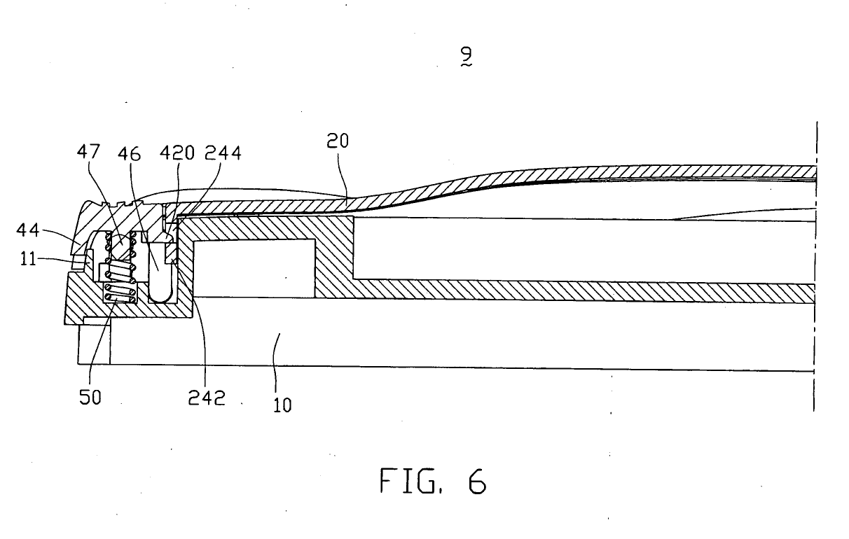

In assembly, also referring to FIGS. 5-6, the spring 50 is attached around the positioning pole 47 of the button 40. The combination of the button 40 and the spring 50 is forced into the button hole 171 of the housing 10 with the outer surface of the button body 41 being exposed outside. During this process, the barbs 452 of the first legs 45 are respectively inserted into the rectangular holes 172 of the housing 10, the pivot pins 462 of the second legs 46 are respectively inserted into the round holes 174 of the housing 10. A first end portion of the spring 50 is received in the mounting hole 177 of the annular protrusion 176 of the housing 10, and the opposite second end portion of the spring 50 abuts against the button body 41. Thus, the button 40 and the spring 50 are mounted to the housing 10. In this state, the spring effectively has a predetermined pressure associated therewith.

The positioning piece 221 of the battery cover 20 is then inserted into the positioning slot 182 of the housing 10. The battery cover 20 is pressed toward the housing 10. When the flake 242 of the battery cover 20 reaches the locking projection 420 of the button 40, the flake 242 continuously moves to thereby press the locking projection 420 to pivot outwardly about the pivot pin 462. During this process, the first end portion of the spring 50 is restricted in the mounting hole 177. The second end portion of the spring 50 around the positioning pole is bent outwardly and an inward restoring force is collected. When the locking projection 420 aligns the locking slot 244 of the flake 242, the restoring force of the spring 50 drives the button 40 to move toward the flake 242 so that the locking projection 420 is snappingly engaged into the locking slot 244 of the flake 242. Thus, the battery cover 20 is assembled with the housing 10.

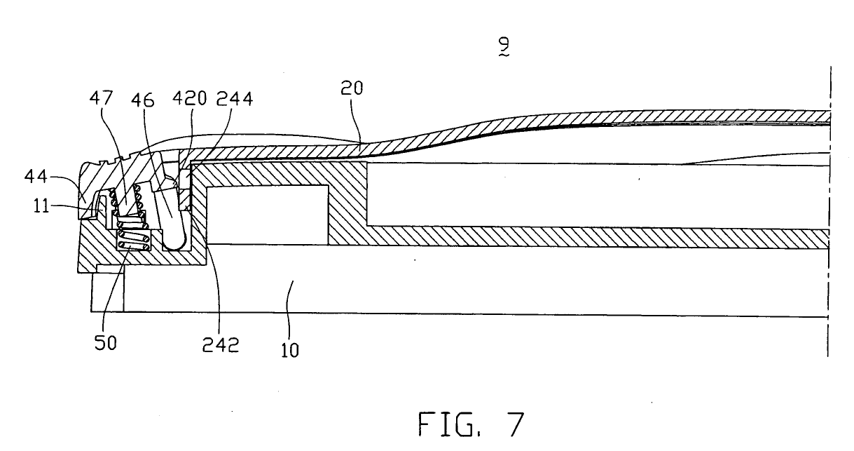

Referring to FIG. 7, in disassembly, the button 40 is pivoted away from the cover 20 by pushing the pusher 410. At the same time, the locking projection 420 is moved away from the flake 242, and the positioning pole 47 is moved away from the cover 20. During this process, the first end portion of the spring 50 is restricted in the mounting hole 177. The second end portion of the spring 50 is bent away from the battery cover and a force is collected. When the locking projection 420 is completely disengaged from the locking hole 244 of the flake 242, the cover 20 can be removed from the housing 10. Then, the button 40 is released, and the force of the spring 50 drives the button 40 back to its original position.

It is to be understood that the button 40 can be fixed with the flake 242 by other means. For example, a locking projection extends from one end of the flake 242. Correspondingly, a locking slot is defined in the button 40 and is engaged with the locking projection of the flake 242. The spring 50 may be omitted, such that the positioning pole 47 of the button 40 is mounted in the mounting hole 177 of the annular protrusion 176. Further, the positioning pole 47 may be directly mounted to the bottom board 1714 to connect the button 40 and the housing 10.

As described above, the preferred embodiment provides a battery cover latching assembly for devices such as mobile phones. When the button is pushed, the cover of the battery cover assembly can be easily removed. This provides the user with convenient operation of the device.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A battery cover latching assembly for use in a portable electronic device, the portable electronic device having a battery cover and a housing connected via the battery cover latching assembly, wherein the battery cover has a fixing means, the housing has a button hole, and the battery cover latching assembly comprises a button with a positioning means, the button is movably installed in the button hole of the housing, wherein the fixing means comprises a flake extending into the button hole, and one of the flake and the positioning means defines a locking slot, and the other of the flake and the positioning means forms a locking projection, the locking projection is snappingly engagable in the locking slot upon pressing the battery cover toward the housing, and is releasable from the locking slot upon pivoting the button away from the flake.

2. The battery cover latching assembly as claimed in claim 1, wherein the button further includes a leg extending from one end thereof, a pivot pin extends perpendicularly from a distal end of the leg, a sidewall of the housing defines a circular hole therein, and the pivot pin of the leg is pivotably mounted in the circular hole.

3. The battery cover latching assembly as claimed in claim 1, wherein the button includes a positioning pole extending therefrom and acting to connect the button and the housing.

4. The battery cover latching assembly as claimed in claim 3, wherein an annular protrusion is formed at a bottom board of the housing and the positioning pole is mounted with the annular protrusion.

5. The battery cover latching assembly as claimed in claim 4, further comprising a spring being placed around the positioning pole.

6. The battery cover latching assembly as claim in claim 5, wherein the spring is in a form a cylinder and is located perpendicular to a pivot axis of the button when the button is located in a latching position where the button and the battery cover are engaged, and the spring around the positioning pole is bent away from the flake when the button is located in a released position where the battery cover is released.

7. A portable electronic device comprising:
a battery cover;
a housing having a button hole defined in one end portion thereof; and
a battery cover latching assembly having a button and a spring, the button and the spring being installed in the button hole of the housing, and the button being movable relative to the housing for assembling or disassembling the battery cover to or from the housing.

8. The portable electronic device as claimed in claim 7, wherein the button includes a positioning pole extending therefrom and one end portion of the spring surrounds the positioning pole.

9. The portable electronic device as claimed in claim 8, wherein an annular protrusion is formed at a bottom board of the housing, and the other opposite end portion of the spring is mounted with the annular protrusion.

10. The portable electronic device as claimed in claim 7, wherein the spring is substantially perpendicular to the battery cover.

11. The portable electronic device as claimed in claim 7, wherein the battery cover has a cutout corresponding to the button hole for exposing the button installed in the button hole.

12. The portable electronic device as claimed in claim 11, wherein the battery cover includes a locking flake extending from an extremity of the cutout into the button hole, the locking flake defines a locking slot therein, the button includes a locking projection snappingly engageable in the locking slot.

13. A latching assembly comprising:
a housing body defining a cavity therein being configured for accommodating a battery therein;
a battery cover removably attached to the housing body for covering the cavity; and
a latching member pivotably attached to the housing body and engaged with the battery cover to latch the battery cover to the housing body, wherein upon pivoting the latching member away from the battery cover, the battery cover is able to be released, and the latching member includes an elastic member for resiliently loading the latch member toward the battery cover.

14. The latching assembly as claimed in claim 13, wherein the housing body defines a recessed portion at one end thereof, and the latching member is received in the recessed portion.

15. The latching assembly as claimed in claim 14, wherein the recessed portion has a sidewall, a pivot is formed on one of the sidewall and the latching member, and a pivot hole is defined in the other of the sidewall and the latching member, the pivot being pivotably received in the pivot hole.

16. The latching assembly as claimed in claim 15, wherein the latching member includes a first leg extending therefrom, the pivot is formed at a distal end of the first leg, and the pivot hole is defined in the sidewall.

17. The latching assembly as claimed in claim 15, wherein the sidewall defines a latch hole therein, and the latching member includes a second leg forming a barb at a distal end thereof, the barb engaged in the latch hole to position the latching member.

18. The latching assembly as claimed in claim 13, wherein the elastic member has opposite first and second end portions engaged with the housing body and the latching member, respectively, and upon pivoting the latching member, the second end portion is bendable away from the battery cover so as to load the latching member toward the battery cover.

19. The latching assembly as claimed in claim 18, wherein the elastic member is a spring member in a form of a hollow cylinder, the latching member forms a positioning pole, the second end portion of the spring member is attached around the positioning pole.

20. The latching assembly as claimed in claim 18, wherein the elastic member is in a form of a hollow cylinder, the housing body forms a hollow protrusion, and the first end portion of the elastic member is restricted in the hollow protrusion.
